(19) United States
(12) Patent Application Publication
(10) Pub. No.: US 2017/0047732 A1
(43) Pub. Date: Feb. 16, 2017

(54) Fault Current Limiter

(71) Applicant: GridON Ltd., Givatayim (IL)

(72) Inventors: Dvir Landwer, Givatayim (IL); Alex Oren, Givatayim (IL); Vladimir Rozeshtein, Givatayim (IL); Uri Garbi, Givatayim (IL)

(21) Appl. No.: 15/306,251

(22) PCT Filed: Apr. 25, 2015
(86) PCT No.: PCT/IL2015/050428

§ 371 Date: Oct. 24, 2016

(30) Foreign Application Priority Data
Apr. 25, 2014 (GB) 1407338.1

(51) Int. Cl. H02H 9/02; H01F 30/12; H01F 27/28

(52) U.S. Cl. CPC H02H 9/021; H01F 27/28; H01F 30/12

(57) ABSTRACT

A fault current limiter is provided that comprises a fault current limiter comprising first, second and third magnetically saturable cores. The fault current limiter comprises a magnetic biasing arrangement arranged to produce a first magnetic circuit in the first magnetically saturable core, a second magnetic circuit in the second magnetically saturable core, and a third magnetic circuit in the third magnetically saturable core; first and second AC coils connected in series and connected to a first phase AC source, wherein the first AC coil is wound on a portion of the first magnetically saturable core and the second AC coil is wound on a portion of the third magnetically saturable core; third and fourth AC coils connected in series and connected to a second phase AC source, wherein the third AC coil is wound on a portion of the first magnetically saturable core and the fourth AC coil is wound on a portion of the second magnetically saturable core; and fifth and sixth AC coils connected in series and connected to a third phase AC source, wherein the fifth AC coil is wound on a portion of the second magnetically saturable core and the sixth AC coil is wound on a portion of the third magnetically saturable core.

The present invention relates to a fault current limiter (FCL).

Faults in electrical power systems cannot be avoided. Fault currents flowing from the sources to a location of the fault lead to high dynamical and thermal stresses being imposed on equipment e.g. overhead lines, cables, transformers and switch gears.

Conventional circuit breaker technology does not provide a full solution to selectively interrupting currents associated with such faults. The growth in electrical energy generation and consumption and the increased interconnection between networks leads to increasing levels of fault current. In particular, the continuous growth of electrical energy generation has the consequence that networks reach or even exceed the limits with respect to their short circuit withstand capability. Therefore, there is a need for devices that are capable of limiting fault currents.

Short circuit currents are rising as transmission and distribution networks expand to address increasing energy demand and connectivity of power generation and intermittent energy sources. These may result in power disruptions, equipment damage and major outages, which have been estimated to cost billions of dollars per year. In order to restrict fault current impact, utility operators have traditionally needed to resort to network segmentation and installation of expensive and lossy protection gear, such as series reactors, capacitors, high rated circuit breakers and high impedance transformers. Such solutions come at the cost of overall reduction of energy efficiency and network stability.

The use of fault current limiters (FCL) allows equipment to remain in service even if the prospective fault current exceeds it rated peak and short-time withstand current. Thus, replacement of equipment (including circuit breakers) can be avoided or postponed to a later time.

A fault current limiter (FCL) can be provided in various forms. One type of fault current limiter involves a fully magnetised (saturated) iron core. Such fault current limiters typically have one or more AC coils wound around an iron core, with the iron core being maintained in a saturated state by a DC bias coil in normal operating conditions. The AC coils are connected to the grid, and in normal conditions the coil is kept saturated, making the FCL virtually transparent to the grid during normal operation.

In a fault condition (e.g. a short-circuit), a current surge will increase the current on the AC coil, causing desaturation of the iron core. As a result of this desaturation of the iron core, the impedance will rise, acting to limit the current on the AC coil. Various arrangements of the saturable core and AC and DC coils are possible. An example of a saturated core FCL is described in WO2007/029224.

The present invention sets out to provide an FCL with improved performance compared to conventional arrangements.

According to an aspect of the invention there is provided a fault current limiter comprising first, second and third magnetically saturable cores, the fault current limiter comprising: a magnetic biasing arrangement arranged to produce a first magnetic circuit in the first magnetically saturable core, a second magnetic circuit in the second magnetically saturable core, and a third magnetic circuit in the third magnetically saturable core; first and second AC coils connected in series and connected to a first phase AC source, wherein the first AC coil is wound on a portion of the first magnetically saturable core and the second AC coil is wound on a portion of the third magnetically saturable core; third and fourth AC coils connected in series and connected to a second phase AC source, wherein the third AC coil is wound on a portion of the first magnetically saturable core and the fourth AC coil is wound on a portion of the second magnetically saturable core; fifth and sixth AC coils connected in series and connected to a third phase AC source, wherein the fifth AC coil is wound on a portion of the second magnetically saturable core and the sixth AC coil is wound on a portion of the third magnetically saturable core.

In some embodiments, the first, second and third magnetically saturable cores each comprise a first leg and a second leg, wherein: the first AC coil is wound on the first leg of the first magnetically saturable core and the second AC coil is wound the second leg of the third magnetically saturable core; the third AC coil is wound on the second leg of the first magnetically saturable core and the fourth AC coil is wound on the first leg of the second magnetically saturable core; the fifth AC coil is wound on the second leg of the second magnetically saturable core and the sixth AC coil is wound on the first leg of the third magnetically saturable core.

In some embodiments, the magnetic biasing unit arrangement comprises: a first DC coil wound on the first leg of the first magnetically saturable core and a second DC coil wound on the second leg of the first magnetically saturable core; a third DC coil wound on the first leg of the second magnetically saturable core and a fourth DC coil wound on the second leg of the second magnetically saturable core; a fifth DC coil wound on the first leg of the third magnetically saturable core and a sixth DC coil wound on the second leg of the third magnetically saturable core.

In some embodiments, the first DC coil and the first AC coil are wound concentrically; the second DC coil and the third AC coil are wound concentrically; the third DC coil and the fourth AC coil are wound concentrically; the fourth DC coil and the fifth AC coil are wound concentrically; the fifth DC coil and the sixth AC coil are wound concentrically; and the sixth DC coil and the second AC coil are wound concentrically.

In some embodiments, the first DC coil is wound around the first AC coil; the second DC coil is wound around the third AC coil; the third DC coil is wound around the fourth AC coil; the fourth DC coil is wound around the fifth AC coil; the fifth DC coil is wound around the sixth AC coil; and the sixth DC coil is wound around the second AC coil. In other embodiments, the AC coils may be wound around the DC coils.

In some embodiments, the magnetic biasing arrangement comprises: a first DC coil wound around the first legs of the first, second and third magnetically saturable cores; a second DC coil wound around the second legs of the first, second and third magnetically saturable cores.

In some embodiments, the first, second and third magnetically saturable cores each further comprise a third leg and a fourth leg, wherein the magnetic biasing unit arrangement comprises: a first DC coil wound on the third leg of the first magnetically saturable core and a second DC coil wound on the fourth leg of the first magnetically saturable core; a third DC coil wound on the third leg of the second magnetically saturable core and a fourth DC coil wound on the fourth leg of the second magnetically saturable core; a fifth DC coil wound on the third leg of the third magnetically saturable core and a sixth DC coil wound on the fourth leg of the third magnetically saturable core.

In some embodiments, the first, second and third magnetically saturable cores each comprise a first leg and a flux return path, wherein: the first AC coil is wound on the first leg of the first magnetically saturable core and the second AC coil is wound the first leg of the third magnetically saturable core; the third AC coil is wound on the first leg of the first magnetically saturable core and the fourth AC coil is wound on the first leg of the second magnetically saturable core; the fifth AC coil is wound on the first leg of the second magnetically saturable core and the sixth AC coil is wound the first leg of the third magnetically saturable core.

In some embodiments, the first AC coil and the third AC coil are wound concentrically; the fourth AC coil and the fifth AC coil are wound concentrically; and the sixth AC coil and the second AC coil are wound concentrically.

In some embodiments, the magnetic biasing arrangement comprises: a first DC coil wound on the first leg of the first magnetically saturable core; a second DC coil wound on the first leg of the second magnetically saturable core; a third DC coil wound on the first leg of the third magnetically saturable core.

In some embodiments, the magnetic biasing the magnetic biasing arrangement comprises a first DC coil wound around the first leg of the first, second and third magnetically saturable core.

In some embodiments, the first AC coil and the first DC coil are wound concentrically; the fourth AC coil and the second DC coil are wound concentrically; and the sixth AC coil and the third DC coil are wound concentrically.

In some embodiments, the first magnetic, the second magnetic circuit, and the third closed magnetic circuit are closed magnetic circuits.

In some embodiments, the magnetic biasing arrangement comprises: a first DC coil wound around the first and second legs of the first magnetically saturable core; a second DC coil wound around the first and second legs of the second magnetically saturable core; a third DC coil wound on the first and second legs of the third magnetically saturable core.

In some embodiments, the magnetic biasing unit arrangement comprises: a DC coil wound around the first and second legs of the first, second and third magnetically saturable cores.

In some embodiments, the first, second and third cores are separate.

In some embodiments, the first, second and third cores are arranged in vertically or horizontally in said same tank; or wherein the first, second and third cores are arranged in separate tanks, each tank being partially or fully filled with a dielectric fluid.

According to an aspect of the invention there is provided a fault current limiter comprising a first magnetically saturable core, the first core including: a first leg, with a first AC coil wound on the first leg; a second leg, with a second AC coil wound on the second leg, the first and second AC coils being connected in series and connected to a first phase AC source; a magnetic biasing unit arranged to produce a DC magnetic circuit in the first leg and the second leg, the magnetic biasing unit comprising a first DC coil wound around the first leg and a second DC coil wound around the second leg; wherein first ends of the first and second legs are joined by a first yoke and second ends of the first and second legs are joined by a second yoke; wherein the first and second AC coils are arranged to produce AC magnetic flux in the first and second legs that alternates in direction with each AC half-cycle.

In some embodiments, the first and second DC coils are arranged to produce the DC magnetic circuit as a closed magnetic circuit, and the first and second AC coils are each arranged to produce an AC magnetic circuit as an open magnetic circuit. In other embodiments, the first and second DC coils are arranged to produce the DC magnetic circuit as an open magnetic circuit, and the first and second AC coils are arranged to produce a closed AC magnetic circuit.

In some embodiments, the first DC coil is wound around the first AC coil and the second DC coil is wound around the second AC coil. In other embodiments, the AC coils are wound around the DC coils.

In some embodiments, the first DC coil and the first AC coil are wound concentrically around the first leg, and the second DC coil and the second AC coil are wound concentrically around the second leg.

In some embodiments, the first and second legs are orientated in the same direction. For example, the first and second legs may be orientated vertically, as this can be advantageous in terms of manufacturing.

In some embodiments, the first and second yokes are orientated in the same direction. For example, the first and second yokes may be arranged horizontally.

In some embodiments, the FCL further comprises a third AC coil wound around the first leg and a fourth AC coil wound around the second leg, the third and fourth AC coils being connected in series and connected to a second phase AC source, wherein the third and fourth AC coils are arranged to produce a second AC magnetic flux in an AC flux direction that alternates with each AC half-cycle. In some such embodiments, the FCL may further comprise a fifth AC coil wound around the first leg and a sixth AC coil wound around the second leg, the fifth and sixth AC coils being connected in series and connected to a third phase AC source, wherein the fifth and sixth AC coils are arranged to produce a third AC magnetic circuit in an AC flux direction that alternates with each AC half-cycle.

In some embodiments, the FCL further comprises a second magnetically saturable core, and a third magnetically saturable core, the second and third cores respectively including: a first leg, with a first AC coil wound on the first leg; a second leg, with a second AC coil wound on the second leg, the first and second AC coils being connected in series; a magnetic biasing unit arranged to produce a DC magnetic circuit in the first leg and the second leg, the magnetic biasing unit comprising a first DC coil wound around the first leg and a second DC coil wound around the second leg; wherein first ends of the first and second legs are joined by a first yoke and second ends of the first and second legs are joined by a second yoke; wherein the first and second AC coils are arranged to produce an AC magnetic circuit in an AC flux direction that alternates with each AC half-cycle; wherein the first and second AC coils of the second magnetically saturable core are connected to a second phase AC source, and the first and second AC coils of the third magnetically saturable core are connected to a third phase AC source.

In some embodiments, each first DC coil is wound around the first AC coil of the respective magnetically saturable core and each second DC coil is wound around the second AC coil of the respective magnetically saturable core.

In some embodiments, on each magnetically saturable core the first DC coil and the first AC coil are wound concentrically around the first leg, and on each magnetically saturable core the second DC coil and the second AC coil are wound concentrically around the second leg.

In some embodiments, the first, second and third cores are separate.

In some embodiments, the first, second and third cores are arranged in vertically or horizontally in said same tank.

In some embodiments, the first, second and third cores are arranged in separate tanks, each tank being partially or fully filled with a dielectric fluid.

According to an aspect of the invention, there is provided a fault current limiter comprising a first magnetically saturable core, the first core including: a first leg, with a first AC coil wound on the first leg; a second leg, with a second AC coil wound on the second leg, the first and second AC coils being connected in series and connected to a first phase AC source; a magnetic biasing unit arranged to produce a DC magnetic circuit in the first leg and the second leg, the magnetic biasing unit comprising at least one DC coil wound around at least one of the first leg and second legs; wherein first ends of the first and second legs are joined by a first yoke and second ends of the first and second legs are joined by a second yoke; wherein the first and second AC coils are arranged to produce AC magnetic flux in the first and second that alternates in direction with each AC half-cycle; wherein the first and second AC coils are arranged to produce an open AC magnetic circuit and the magnetic biasing unit is arranged to produce a closed DC magnetic circuit, or the first and second AC coils are arranged to produce a closed AC magnetic circuit and the magnetic biasing unit is arranged to produce an open DC magnetic circuit.

According to an aspect of the invention, there is provided a fault current limiter comprising a first magnetically saturable core, a second magnetically saturable core, and a third magnetically saturable core, each magnetically saturable core respectively including: a first leg, with a first AC coil wound on the first leg; a second leg, with a second AC coil wound on the second leg, the first and second AC coils being connected in series; a magnetic biasing unit arranged to produce a DC magnetic circuit in the first leg and the second leg; wherein first ends of the first and second legs are joined by a first yoke and second ends of the first and second legs are joined by a second yoke; wherein the first and second AC coils are arranged to produce an AC magnetic circuit in an AC flux direction that alternates with each AC half-cycle; wherein the first and second AC coils of the first magnetically saturable core are connected to a first phase AC source, the first and second AC coils of the second magnetically saturable core are connected to a second phase AC source, and the first and second AC coils of the third magnetically saturable core are connected to a third phase AC source.

In some embodiments, the magnetic biasing unit of each magnetically saturable core comprises a first DC coil wound around the first leg and a second DC coil wound around the second leg.

In some embodiments, each first DC coil is wound around the first AC coil of the respective magnetically saturable core and each second DC coil is wound around the second AC coil of the respective magnetically saturable core.

In some embodiments, on each magnetically saturable core the first DC coil and the first AC coil are wound concentrically around the first leg, and on each magnetically saturable core the second DC coil and the second AC coil are wound concentrically around the second leg.

In some embodiments, the magnetic biasing units of the first, second and third magnetically saturable cores comprise a common DC coil for the first, second and third magnetically saturable cores, the common DC coil being wound around both the first and second legs of all of the magnetically saturable cores.

In some embodiments, the magnetic biasing units of the first, second and third magnetically saturable cores comprise a first DC coil wound around the first legs of the first, second and third magnetically saturable cores, and a second DC coil wound around the second legs of the first, second and third magnetically saturable cores.

According to an aspect of the invention there is provided a fault current limiter comprising a fault current limiter comprising a first magnetically saturable core, the first core including: a first leg, with a first AC coil wound on the first leg; a second leg, with a second AC coil wound on the second leg, the first and second AC coils being connected in series and connected to a first phase AC source; a magnetic biasing unit arranged to produce a DC bias flux via magnetic circuit in the first leg and the second leg, the magnetic biasing unit comprising a first DC coil wound around the first leg and a second DC coil wound around the second leg; wherein first ends of the first and second legs are joined by a first yoke and second ends of the first and second legs are joined by a second yoke; wherein the first and second AC coils are arranged to produce an AC magnetic flux in direction supported DC flux in one leg and opposed to DC flux in other leg that alternates with each AC half-cycle.

According to an aspect of the invention there is provided fault current limiter comprising a first magnetically saturable core, the first core including: a first leg, with a first AC coil wound on the first leg; a second leg, with a second AC coil wound on the second leg, the first and second AC coils being connected in series and connected to a first phase AC source; a magnetic biasing unit arranged to produce a biasing magnetic circuit in the first leg and the second leg; wherein first ends of the first and second legs are joined by a first yoke and second ends of the first and second legs are joined by a second yoke; wherein the first and second AC coils are arranged to produce AC magnetic flux in the first and second that alternates in direction with each AC half-cycle; wherein the first and second AC coils are arranged to produce an open AC magnetic circuit and the magnetic biasing unit is arranged to produce a closed biasing magnetic circuit, or the first and second AC coils are arranged to produce a closed AC magnetic circuit and the magnetic biasing unit is arranged to produce an open biasing magnetic circuit.

In some embodiments, the magnetic biasing unit may use at least one non-HTS DC coil.

Embodiments of the invention will now be described, by way of example and with reference to the accompanying drawings in which:—

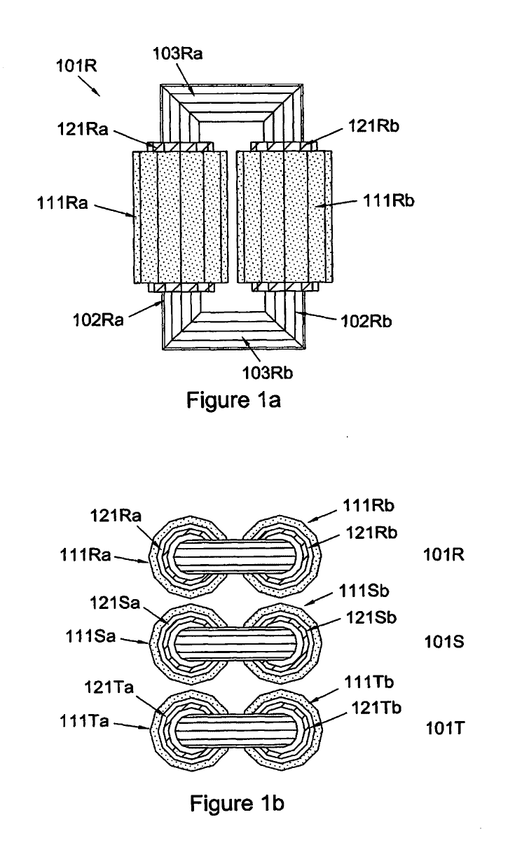

FIGS. 1a and 1b show a schematic of an FCL 100 according to a first embodiment of the invention;

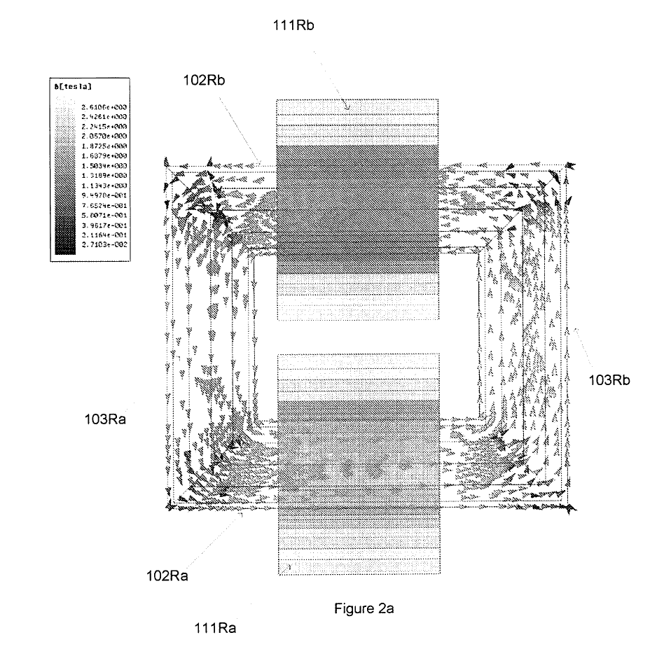

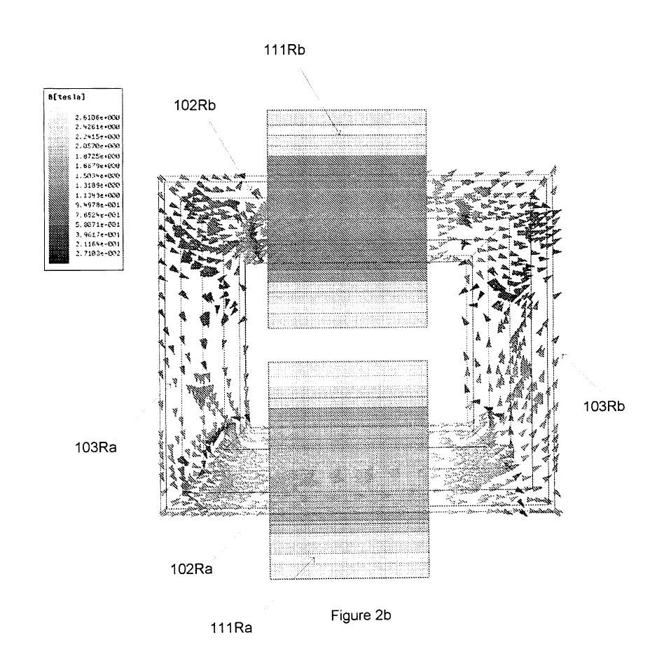

FIG. 2a shows a model of flux density (B) for the embodiment of FIGS. 1a and 1b at a maximum AC current point in normal conditions,

FIG. 2b shows a model of flux density (B) for the embodiment of FIGS. 1a and 1b at a maximum AC current point in fault conditions;

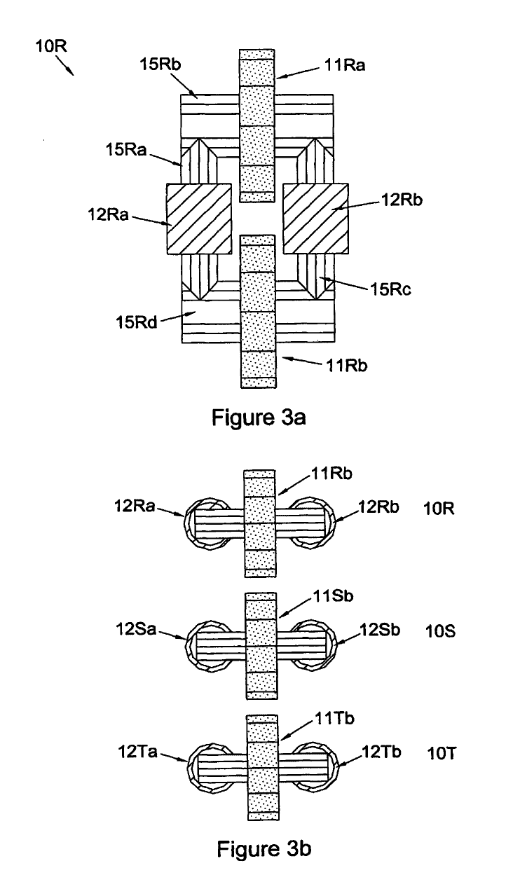

FIGS. 3a and 3b show a schematic of a comparative example FCL 10;

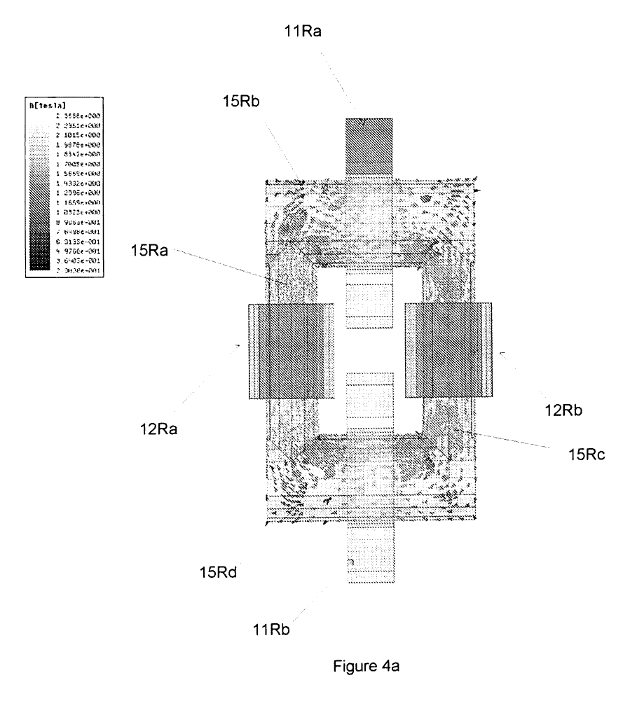

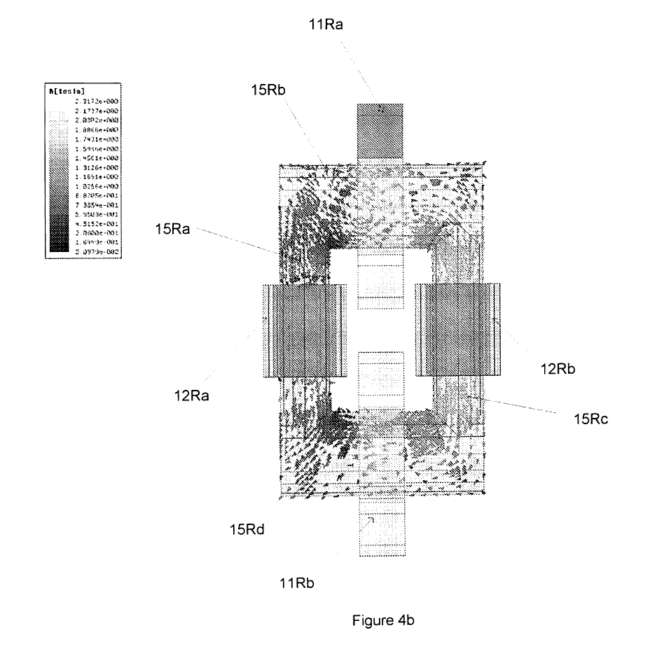

FIG. 4a shows a model of flux density (B) for the comparative example of FIGS. 3a and 3b at a maximum AC current point in normal conditions,

FIG. 4b shows a model of flux density (B) for the comparative example of FIGS. 3a and 3b at a maximum AC current point in fault conditions;

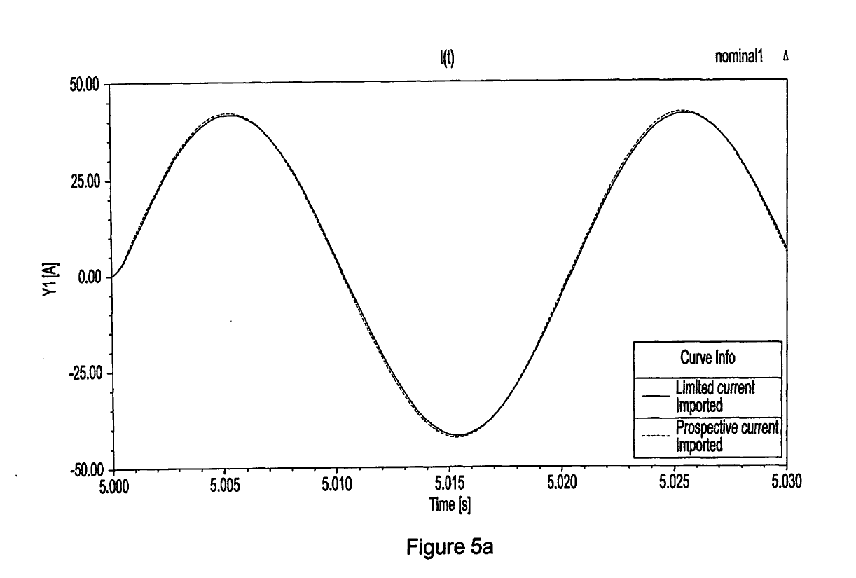

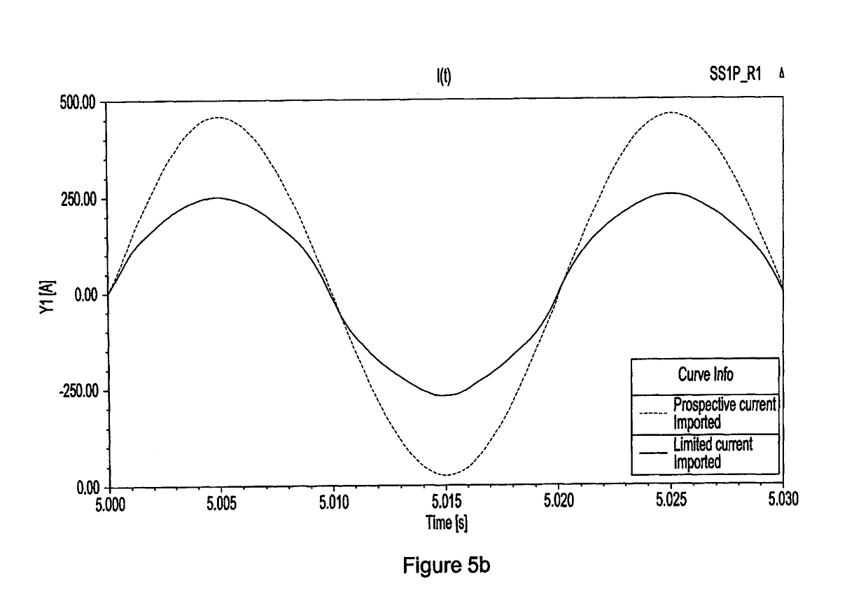

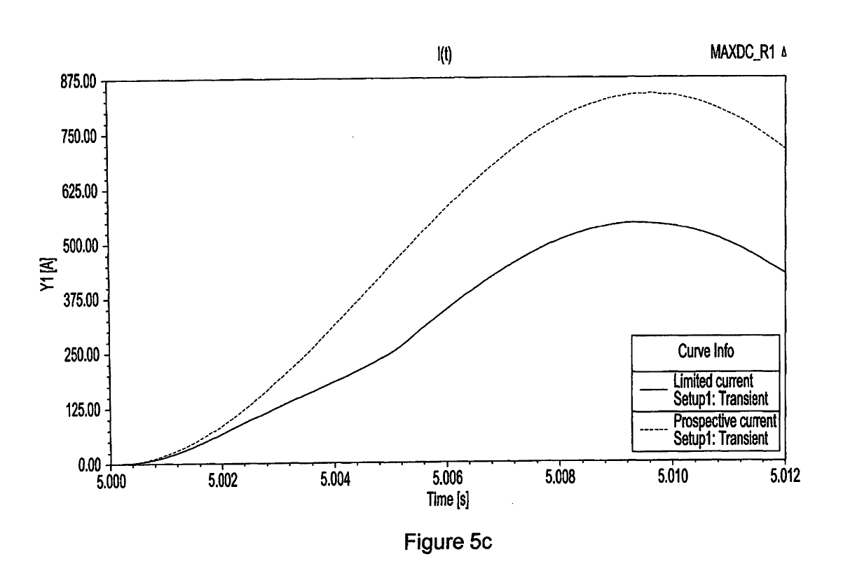

FIG. 5a shows a graph of current against time for Comparative Example 1 under normal conditions;

FIG. 5b shows a graph of current against time for Comparative Example 1 under steady state fault conditions (short circuit);

FIG. 5c shows a graph of current against time for Comparative Example 1 for a maximum asymmetry fault condition;

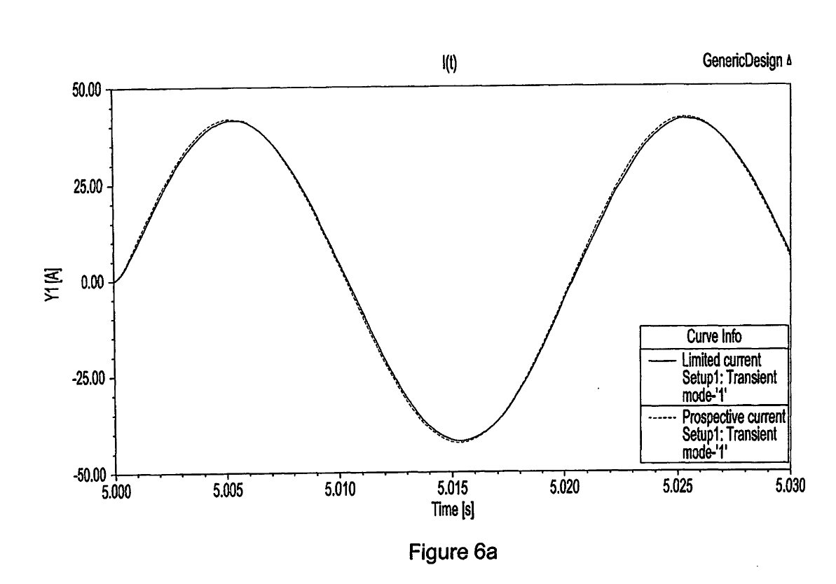

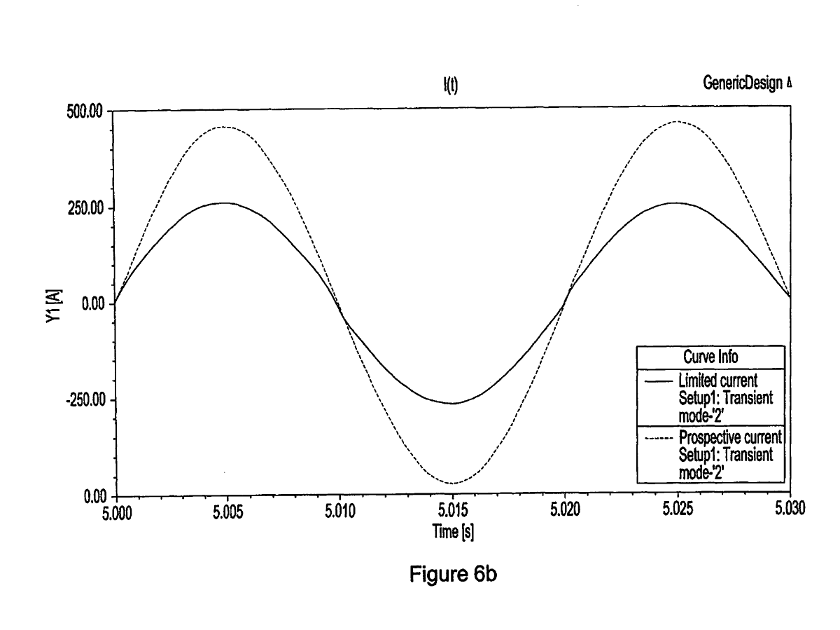

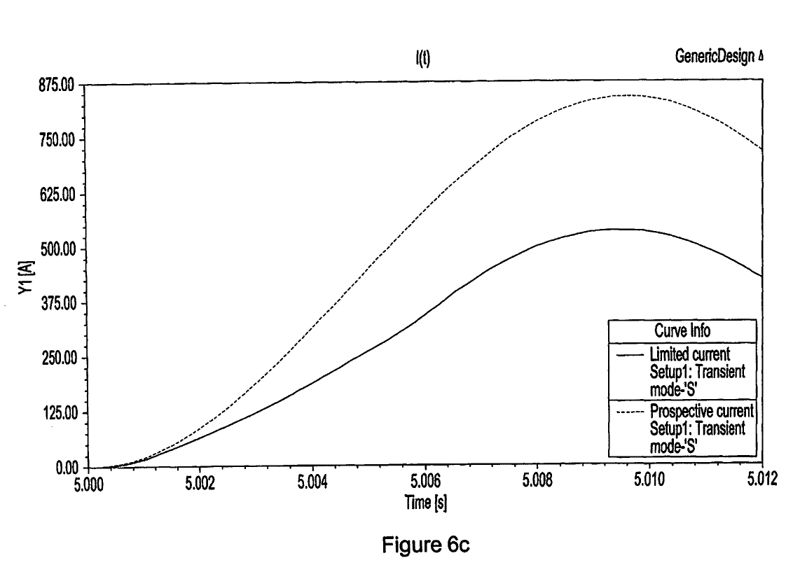

FIG. 6a shows a graph of current against time for Embodiment 1 under normal conditions;

FIG. 6b shows a graph of current against time for Embodiment 1 under steady state fault conditions (short circuit);

FIG. 6c shows a graph of current against time for Embodiment 1 for a maximum asymmetry fault condition;

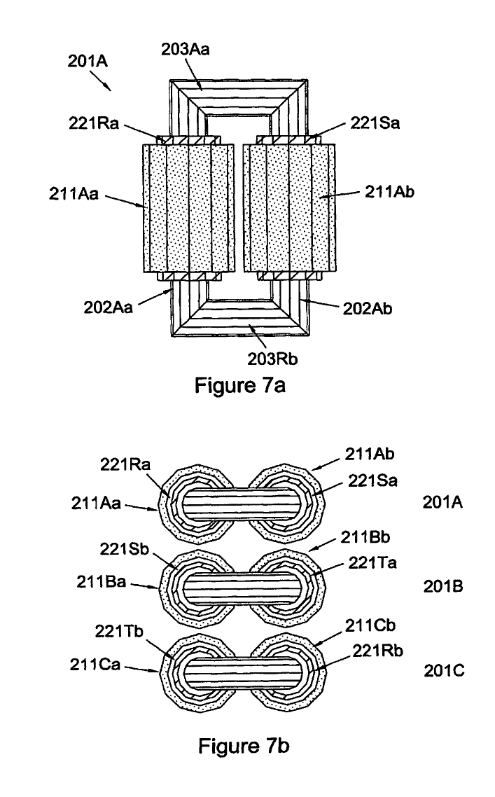

FIGS. 7a and 7b show a schematic of an FCL according to a second embodiment;

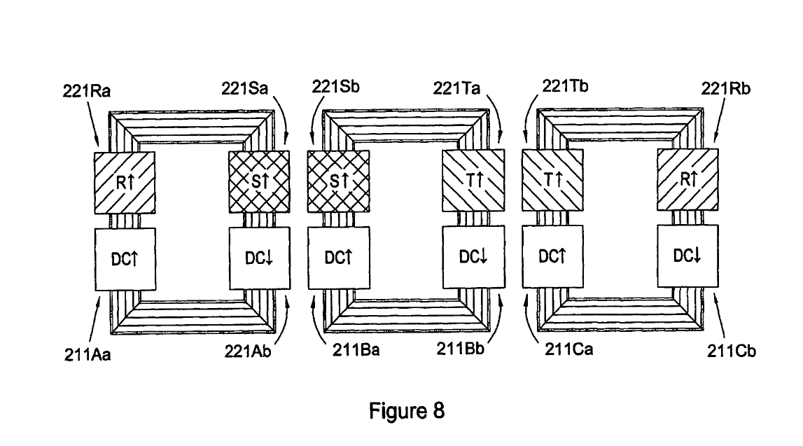

FIG. 8 shows a schematic of the orientations of the AC and DC coils in the FCL according to the second embodiment;

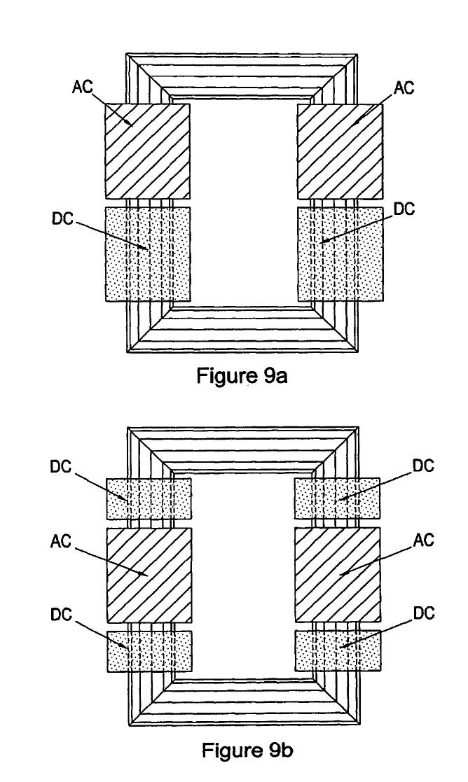

FIGS. 9a and 9b schematically show variations of the first and second embodiments;

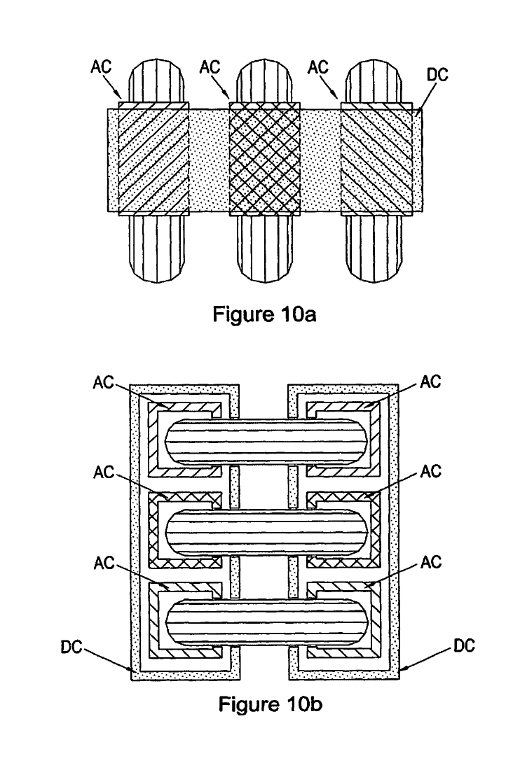

FIGS. 10 and 10b schematically show a third embodiment;

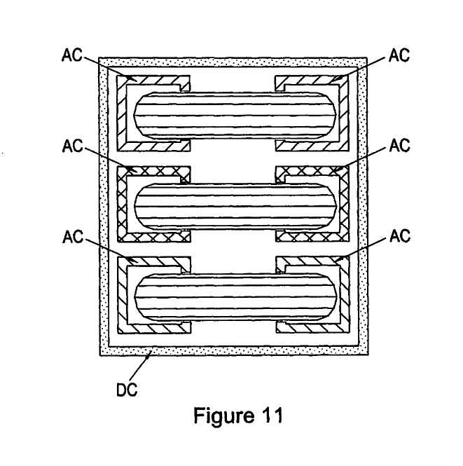

FIG. 11 schematically shows a fourth embodiment;

FIGS. 1a and 1b show a schematic of an FCL 100 according to a first embodiment of the invention.

The FCL 100 has three ferromagnetic cores 101R, 101S and 101T for each of the phases (R, S and T) of a three phase AC supply. FIG. 1b shows a top down view of the three ferromagnetic cores 101R, 101S, and 101T; while FIG. 1a shows a side view of the ferromagnetic core 101R for the R phase.

The ferromagnetic core 101R for the R phase comprises a first leg 102Ra and a second leg 102Rb. One end of the first and second legs is connected by a first yoke 103Ra and the other end of the first and second legs is connected by a second yoke 103Rb.

A first AC coil 121Ra is wound on the first leg 102Ra and a second AC coil 121Rb is wound on the second leg 102Rb, with the first and second AC coils 121Ra, 121Rb connected in series. A first DC coil 111Ra is wound around the first leg 102Ra and a second DC coil 111Rb is wound around the second leg 102Rb. In this embodiment, the DC coil on each leg is wound around the AC coil in a concentric arrangement.

The ferromagnetic cores 101S, 101T for the S and T phases are configured in a similar way. For the S phase, a first AC coil 121Sa is wound on the first leg 102Sa of the core 101S, and a second AC coil 121Sb is wound on the second leg 102Sb, with the first and second AC coils 121Sa, 121Sb connected in series. A first DC coil 111Sa is wound around the first leg 102Sa and a second DC coil 111Sb is wound around the second leg 102Sb. For the T phase, a first AC coil 121Ta is wound on the first leg 102Ta of the core 101T, and a second AC coil 121Tb is wound on the second leg 102Tc, with the first and second AC coils 121Ta, 121Tb connected in series. A first DC coil 111Ta is wound around the first leg 102Ta and a second DC coil 111Tb is wound around the second leg 102Tb.

The legs and yokes of the cores 101R, 101S and 101T have, in this embodiment, interleaved, mitred, step-lapped joints. However, other embodiments can employ simpler arrangements, using non-mitred, butt-lapped joints. The core is built from grain-oriented sheet steel laminations, though other embodiments could use alternative core structures. The coils (AC and DC) are made of electrolytic grade copper in this arrangement. However, other embodiments could use alternative materials for the coils.

The FCL 100 of this embodiment can further comprise a tank (not shown) arranged to house the three cores 101R, 101S and 101T. The tank can be partially or completely filled with a dielectric fluid. Any suitable dielectric fluid could be used, for example mineral oil or vegetable oil (which have been found to be suitable as a dielectric for voltages up to 300 kV and beyond).

In this embodiment, the two DC coils on each core provides a magnetic biasing means for that core that provides a closed magnetic circuit. The first DC coil 111Ra and the second DC coil 111Rb combine to produce a closed DC flux path inside (around) the first and second legs of each core. In this embodiment, the closed DC flux flows in a counter clockwise direction. For example, for the core 101R, the closed DC flux flows from the first DC coil 111Ra along the first leg 102Ra to the second leg 102Rb via the second yoke 103Rb then back to the first leg 102Ra via the first yoke 103Ra.

It will be appreciated that the first and second DC coils 111Sa and 111Sb will a corresponding closed DC flux path in the S core 101S, and that the first and second DC coils 111Ta and 111Tb will create a closed DC flux path in the T core 101T in a similar way.

In this embodiment, the AC coils for each core 101R, 101S, 101T are wound so as to each produce a open AC magnetic circuit that opposes the DC flux in one leg and supports the DC flux in the other leg, with the situation reversing in the next half cycle. In other words, taking the core 101R as an example, the first AC coil 121Ra is wound on the first leg 102Ra and the second AC coil 121Rb is wound on the second leg 102Ra in the opposite sense. It will be appreciated that these AC coils may be wound in same direction but connected in appropriate way.

Hence, in first half cycle, the first AC coil 121Ra will produce flux that supports the DC flux in the first leg 102Ra and the second AC coil 121Rb will produce flux that opposes the DC flux in the second leg 102Rb. The flux from the first and second AC coils will return in open magnetic circuits.

It will be appreciated that the term “open magnetic circuit” refers to a magnetic circuit that has a path through air, as opposed to a “closed magnetic circuit” that flows through the core.

In the next half cycle, the first AC coil 121Ra will produce flux that opposes the DC flux in the first leg 102Ra and the second AC coil 121Rb will produce flux that supports the DC flux in the second leg 102Rb.

FIG. 2a shows a model of flux density (B), i.e. adding the flux contributions of the AC and DC magnetic circuits, for the core 101R of FIGS. 1a and 1b at a maximum AC current point in normal conditions.

The flux produced by the first DC coil 111Ra and the second DC coil 111Rb combines to produce a closed DC flux path in a counter clockwise direction in this embodiment. In the half cycle shown in FIG. 2a, the flux produced by the second AC coil 121Rb opposes (while still maintaining saturation) the DC flux in the second leg 102Rb and the flux produced by the first AC coil 121Ra supports the DC flux in the first leg 102Ra.

This arrangement of the AC magnetic circuit supporting/opposing the DC magnetic circuits will reverse in the next half cycle during normal conditions, with the first leg 102Ra becoming less saturated (while still maintaining saturation) and the second leg 102Ra becoming more saturated.

Under normal conditions, the first and second legs 102Ra, 102Rb are kept in a saturated state (with one leg being more saturated than the other leg). Hence, under normal conditions, the first and second AC coils 121Ra, 121Rb have very low impedance, and hence the FCL 100 is virtually transparent to the grid connected to the FCL 100.

FIG. 2b shows a model of flux density (B) for the core 101R of FIGS. 1a and 1b at an AC peak current during a fault condition. In this fault condition, there is a short circuit on the R phase of the three phase supply.

The general arrangement of the DC and AC magnetic circuits in FIG. 2b is the same as those described in the nominal current state in FIG. 2a, except the magnitude of the AC flux is increased due to the higher AC current in the short circuit state. Hence, in the short circuit state, the effect of the AC magnetic flux supporting the DC flux in one leg and opposing the DC flux in the other inner leg is magnified.

As for FIG. 2a, the flux produced by the first DC coil 111Ra and the second DC coil 111Rb combines to produce a closed DC flux path in a counter clockwise direction in FIG. 2b. In the half cycle shown in FIG. 2b, the flux produced by the second AC coil 121Rb acts to oppose the DC flux in the second leg 102Rb and the flux produced by the first AC coil 121Ra acts to support the DC flux in the first leg 102Ra.

As shown in FIG. 2b, the increase of the AC magnetic flux supporting/opposing the DC magnetic flux has the effect of (in this half cycle) putting the first leg 102Ra into very high saturation, whilst putting the second leg 102Rb into an unsaturated state (or saturated in the opposite direction to the second leg 102Rb in FIG. 2a), with the flux direction reversed when compared to the direction of the flux in the second leg 102Rb in FIG. 2a (i.e. in normal conditions).

The effect of the second leg 102Rb being in the unsaturated state in FIG. 2b will be that the impedance of the coil on the second leg 102Rb will increase, acting to limit the fault current.

The situation in the next AC half cycle will reverse, with the first leg 102Ra being put out of saturation (and hence its impedance will rise), with the second leg 102Ra being more saturated. Hence, during fault conditions, in every half-cycle, one of the first or second legs will be out of saturation, ensuring a high impedance state. This alternation of raising impedance in the AC coils on one of the first and second legs continues until the fault is cleared.

FCLs according to the present invention are associated with a number of benefits compared to conventional arrangements, as will be discussed in more detail below.

FIGS. 3a and 3b show a schematic of an FCL 10 according to a comparative example.

The FCL 10 has three ferromagnetic cores 10R, 10S and 10T for each of the phases (R, S and T) of a three phase AC supply. FIG. 3b shows a top down view of the three ferromagnetic cores 10R, 10S, and 10T; while FIG. 3a shows a side view of the ferromagnetic core 10R for the R phase.

The ferromagnetic core 10R for the R phase comprises a first leg 15Ra, a second leg 15Rb, a third leg 15Rc, and a fourth leg 15Rd. The first to fourth legs are connected in an orthogonal arrangement with the first leg 15Ra being opposite to the third leg 15Rc and the second leg 15Rb being opposite to the fourth leg 15Rd.

A first AC coil 12Ra is wound on the first leg 15Ra and a second AC coil 12Rb is wound on the third leg 15Rc, with the first and second AC coils 12Ra, 12Rb connected in series. A first DC coil 11Ra is wound around the second leg 15Rb and a second DC coil 11Rb is wound around the fourth leg 15Rd. Hence, the first and second AC coils 12Ra, 12Rb are wound on opposite legs and the first and second DC coils 11Ra, 11Rb are also wound on opposite legs (different to the legs of the AC coils). The ferromagnetic cores 10S, 10T for the S and T phases are configured in a similar way.

The legs of the cores 10R, 10S and 10T have, in this example, interleaved, mitred, step-lapped joints. The coils (AC and DC) are made of electrolytic grade copper in this arrangement.

The FCL to of this example can comprises a tank (not shown) arranged to house the three cores 10R, 10S and 10T. In this example, the two DC coils on each core provides a DC biasing means for that core. Hence, the first DC coil 11Ra and the second DC coil 11Rb combine to produce a closed DC flux path around the first to fourth legs of each core.

In this example, the closed DC flux flows in a clockwise direction. For example, for the core 10R, the closed DC flux flows from the first DC coil 11Ra along the second leg 15Rb to the third leg 15Rc, from the third leg 15Rc to the fourth leg 15Rd, from the fourth leg 15Rd to the first leg 15Ra and back to the second leg 15Rb.

It will be appreciated that the first and second DC coils 11Sa and 11Sb will a corresponding closed DC flux path in the S core 10S, and that the first and second DC coils 11Ta and 11Tb will create a closed DC flux path in the T core 10T in a similar way.

In this arrangement, the AC coils for each core 10R, 10S, 10T are wound so as to each produce a open AC magnetic circuit that opposes the DC flux in one leg and supports the DC flux in the other leg, with the situation reversing in the next half cycle. In other words, taking the core 10R as an example, the first AC coil 12Ra is wound on the first leg 15Ra and the second AC coil 12Rb is wound on the third leg 15Rc in the opposite sense.

Hence, in first half cycle, the first AC coil 12Ra will produce flux that opposes the DC flux in the first leg 15Ra and the second AC coil 12Rb will produce flux that supports the DC flux in the third leg 15Rc. The flux from the first and second AC coils will return through air i.e. it has open magnetic circuits.

In the next half cycle, the first AC coil 12Ra will produce flux that opposes the DC flux in the first leg 15Ra and the second AC coil 12Rb will produce flux that supports the DC flux in the third leg 15Rc.

FIG. 4a shows a model of flux density (B), i.e. adding the flux contributions of the AC and DC magnetic circuits, for the core 10R of FIGS. 3a and 3b at a maximum AC current point in normal conditions.

The flux produced by the first DC coil 11Ra and the second DC coil 11Rb combines to produce a closed DC flux path in a clockwise direction in this example. In the half cycle shown in FIG. 4a, the flux produced by the second AC coil 12Rb supports the DC flux in the third leg 15Rc and the flux produced by the first AC coil 12Ra opposes (while still maintaining saturation) the DC flux in the first leg 15Ra.

This arrangement of the AC magnetic circuit supporting/opposing the DC magnetic circuits will reverse in the next half cycle during normal conditions, with the third leg 15Rc becoming less saturated (while still maintaining saturation and the first leg 15Ra becoming more saturated.

Under normal conditions, the first and third legs 15Ra, 15Rc are kept in a saturated state (with one of these legs being more saturated than the other). Hence, under normal conditions, the first and second AC coils 12Ra, 12Rb have very low impedance.

FIG. 4b shows a model of flux density (B) for the core 10R of FIGS. 3a and 3b at an AC peak current during a fault condition. In this fault condition, there is a short circuit on the R phase of the three phase supply.

The general arrangement of the DC and AC magnetic circuits in FIG. 4b is the same as those described in the nominal current state in FIG. 4a, except the magnitude of the AC flux is increased due to the higher AC current in the short circuit state. Hence, in the short circuit state, the effect of the AC magnetic flux supporting the DC flux in one AC leg and opposing the DC flux in the other AC leg is magnified.

As for FIG. 4a, the flux produced by the first DC coil 11Ra and the second DC coil 11Rb combines to produce a closed DC flux path in a clockwise direction in FIG. 4b. In the half cycle shown in FIG. 4b, the flux produced by the first AC coil 12Ra acts to oppose the DC flux in the first leg 15Ra and the flux produced by the second AC coil 12Rb acts to support the DC flux in the third leg 15Rc.

As shown in FIG. 4b, the increase of the AC magnetic flux supporting/opposing the DC magnetic flux has the effect of (in this half cycle) putting the third leg 15Rc into very high saturation, whilst putting the first leg 15Ra into an unsaturated state.

The effect of the first leg 15Ra being in the unsaturated state in FIG. 4b will be that the impedance of the AC coil on the first leg 15Ra will increase, acting to limit the fault current.

The situation in the next AC half cycle will reverse, with the third leg 15Rc being put out of saturation (and hence its impedance will rise), with the first leg 15Ra being more saturated. Hence, during fault conditions, in every half-cycle, one of the first or second legs will be out of saturation, ensuring a high impedance state. This alternation of raising impedance in the AC coils on one of the first and third legs continues until the fault is cleared.

A comparison will now be made between an example FCL 10 configured in the manner of FIGS. 3a and 3b, and the FCL too according to the first embodiment.

It will be appreciated that the performance of an FCL configuration will vary as certain parameters are varied. For example, DC saturation will increase, with increasing DC turns. It will also be appreciated that the size of the FCL (e.g. cross section of the legs) will affect the performance of the FCL configuration.

It will be appreciated that, in a system with significantly large inductance compared to resistance (e.g. X/R ratio>10) the fault condition can include a degree of asymmetry. For example, if the fault occurs at the instant in which the system voltage is maximum positive, then the fault current will be symmetric. If on the other hand the fault occurs when the system voltage is zero, the fault current will have maximum asymmetry which is manifested as a DC component superimposed on the AC component of the fault current. The presence of resistance in the circuit causes this DC component to decay over several cycles.

A maximum asymmetric fault condition therefore represents the maximum possible fault current. Not all faults have this asymmetry.

In this comparison, certain FCL parameters were fixed for an FCL according to an embodiment of the present invention (Example 1) and a comparative example (Comparative Example 1), and then other FCL parameters were varied with the aim of making it so that all the FCL configurations have the same (or very nearly the same) current limitation for a maximum asymmetric fault condition, with the same prospective steady state rms fault current.

In other words, in order to compare the FCL configurations of the first embodiment and the comparative example, specific FCLs according to each configuration were simulated, with certain FCL parameters fixed between the four configurations and others varied in order to produce the same current limitation for maximum asymmetric fault conditions. By doing this, various properties of the FCL configurations can be directly compared.

In this comparison, the following grid parameters were fixed:
Power: 52 kVA
Line-Line voltage: 1000V
Line-ground voltage: 580V
Nominal current: 30 A
Prospective current: 330 A

In this comparison, the following FCL parameters were fixed:
AC Leg diameter: 65 mm
AC Leg length: 187 mm
AC winding number of turns: 102
AC winding length: 107 mm
AC winding inner diameter: 81 mm
AC winding outer diameter: 105 mm

Simulations were performed in normal conditions, steady state fault conditions (short circuit) and maximum asymmetry fault conditions.

FIG. 5a shows a graph of current against time for the example of FIGS. 3a and 3b (Comparative Example 1) under normal conditions. As can be seen, the “prospective current” and the “limited current” are equal.

FIG. 5b shows a graph of current against time for the example of FIGS. 3a and 3b (Comparative Example 1) under steady state fault conditions (short circuit). As can be seen, the “prospective current” is more than the “limited current”. A “steady state fault” refers to a fault condition in which the positive and negative current peaks are equal.

FIG. 5c shows a graph of current against time for the example of FIGS. 3a and 3b (Comparative Example 1) for the maximum asymmetry fault condition. Hence, FIG. 5c shows the maximum possible fault current and first peak limitation.

FIG. 6a shows a graph of current against time for the embodiment of FIGS. 2a and 2b (Example 1) under normal conditions.

FIG. 6b shows a graph of current against time for the embodiment of FIGS. 2a and 2b (Example 1) under steady state fault conditions (short circuit).

FIG. 6c shows a graph of current against time for the embodiment of FIGS. 2a and 2b (Example 1) for the maximum asymmetry fault.

In this comparison, it was attempted to achieve similar limiting performance for both Example 1 and Comparative Example 1.

Table 1 compares the nominal performances of Example 1 and Comparative Example 1.

TABLE 1

| | Nominal rms | Voltage Drop |
|---|---|---|
| | Current | on FCL |
| Arrangement | [A] | [V]] |
| Example 1 | 29.6 | 12.3 |
| Comparative | 29.6 | 11.8 |
| Example 1 | | |

Table 2 compares the limiting performances of Example 1 and Comparative Example 1.

TABLE 2

| | Steady state | | | Maximum asymmetry | | |
|---|---|---|---|---|---|---|
| | | Limited | | | Limited | |
| | Prospective | rms | | Prospective | peak | |
| | rms | current | Current | peak | current | Current |
| Arrangement | current [A] | [A] | limitation | current [A] | [A] | limitation |
| Example 1 | 330.16 | 185.17 | 43.91 | 839.45 | 534.96 | 36.27% |
| Comparative | 330.16 | 188.84 | 42.90 | 839.45 | 544.69 | 35.11% |
| Example 1 | | | | | | |

Table 3 compares DC ampere-turns and DC power losses.

TABLE 3

| | DC ampere-turns | DC losses |
|---|---|---|
| Arrangement | [AT] | [kW] |
| Example 1 | 6400 | 1.22 |
| Comparative | 11000 | 2.90 |
| Example 1 | | |

Table 4 compares masses and dimensions.

TABLE 4

| | Yokes | | | | |
|---|---|---|---|---|---|
| | diameter | Dimensions | | | Basic mass |
| Arrangement | [mm] | L [mm] | W [mm] | H [mm] | [kg] |
| Example 1 | 65 | 462 | 655 | 403 | 232 |
| Comparative | 110 | 389 | 901 | 683 | 425 |
| Example 1 | | | | | |

As discussed, the four FCLs in this comparison share the same fixed parameters. The other parameters (e.g. legs and yokes cross-section) were varied, resulting in each FCL having different legs and yokes cross-section and different masses.

As can be seen from Table 1, the e two FCLs in this comparison have similar nominal performance.

In the comparison the same prospective peak current for maximum asymmetric fault conditions was simulated, as well as the same prospective rms current for a steady state fault. As can be seen from Table 2, the two FCLs in this comparison have similar % current limitation for a maximum asymmetry fault (with Example 1 having better performance), as this is what the two FCLs in this comparison were designed to have. Also, the values of the prospective rms current in Table 3 are the same for each FCL configuration in the comparison.

Also from Table 2, it is clear that Comparison Example 1 has a slightly higher limited rms current, resulting in a lower % current limitation for a steady state fault.

Comparison Example 1 has a slightly higher limited rms current, resulting in a lower limiting impedance for a steady state fault.

Table 2 shows that Comparative Example 1 requires significantly more DC ampere-turns that Example 1 to achieve the same (or slightly worse) fault limiting capabilities. Also, Table 2 shows that Comparative Example 1 is associated with higher DC losses that Example 1.

Table 3 clearly shows a significant reduction in size in the FCL configuration of Example 1 when compared to Comparative Example 1. Comparative Example 1 has a significantly larger diameter for “yokes” when compared to Example 1 which leads to a large increase in mass and core dimensions. It will be appreciated that the “yokes” of the Comparative Example 1 are the “second leg” and “fourth leg” of FIGS. 3a and 3b.

Hence, it is clear from Tables 1, 2 and 3 that Example 1 shows improved performance under steady state fault conditions when compared to Comparative Example 1, while being significantly smaller and lighter and with lower losses.

Without being bound by theory, the improved performance of Example 1 when compared to Comparative Example 1 is considered to arise from the closer proximity of the DC coils to the AC coils. In Comparative Example 1, the DC coils are on different legs (i.e. the second and fourth legs) to the AC coils (i.e. the first and third legs), but need to saturate the legs of the AC coils.

Considering the DC coil 11a on the second leg 15b of FIG. 3a, the flux from this DC coil needs to pass along the second leg 15b to the first leg 15a in order to saturate the first leg 15a. In order to provide sufficient saturation on the first leg 15a, the cross section of the first leg 15a and the second leg 15b (i.e. the “yoke”) has to be sufficiently high.

In Example 1, the DC coils surround the legs of the FCL (i.e. the first and second legs), which means that a lower cross sectional area of the yoke can be used in order to achieve the same saturation while maintaining a closed DC magnetic circuit.

Hence, in Example 1 there is very efficient saturation of the first and second legs, which can lead to FCLs with lower mass and lower footprint for the same maximum asymmetry performance.

In addition, the arrangement of Example 1 is easier to manufacture that the arrangement of Comparative Example 1.

In the embodiment of FIGS. 1a and 2b, the two legs are arranged vertically, and hence all the coils (DC and AC) are wound around vertical legs. Coils wound around vertical legs are preferred to coils wound around horizontal legs for a number of reasons. One reason is performance when arranged in a tank comprising a dielectric such as oil. In coils wound around vertical legs, hot oil (being lighter) rises to the top of the winding, setting up a thermosyphon effect due to gravity. This oil head drives oil through the windings to reduce conductor temperature. In horizontal arrangements, oil cannot travel vertically, and will be stagnant and create higher temperature in the windings. To compensate, larger section conductor is needed or more cooling ducts provided to cool the windings at extra cost.

Vertically oriented DC and AC coils provide good control over conductor temperature through efficient oil movement.

In addition, during manufacture of embodiments of the invention that use vertically arranged legs, the bottom yoke and legs can first built in on a horizontal table. This assembly can then be up-ended and the two DC and two AC coils can be lowered on the legs. The top yoke can then be inserted to join the legs. This is a safe, and relatively fast building process. By contrast, horizontal windings cannot be lowered on to legs. They have to be hung/supported in the air whilst core laminations are inserted through the inside of the windings. This slows the manufacturing process. Also, if the horizontal coil is to be placed in the top yoke, the coil support while inserting the laminations poses a safety hazard for people working below the coil.

Furthermore, it is possible to rigidly supporting all windings from the tank bottom via core feet-bottom frame-bottom blocks. Core-coil assembly is well supported during shipping and is more stable under short circuit forces. The horizontally slung DC coils in conventional arrangements (besides being a safety hazard during Core-coil assembly) are not well supported during assembly, operation and short circuit.

Another advantage of Example 1 over Comparative Example 1 is in the magnetic field generated around the device. Due to the lower amount of Ampere-Turns of Example 1 (to achieve similar performance)—the magnetic field around the device is significantly reduced, which is a desired property by operators.

Hence, while designing both devices for the same performances, using the configuration of Example 1 provides the following advantages:

a. Mass and dimensions reduction.
b. Reduction of DC losses and DC current required for acceptable nominal behaviour
c. Easier manufacturing
d. Significant reduction of magnetic flux outside the fault current limiter

These advantages are mainly derived from moving DC coil to be on the same legs with AC coils.

Arranging the DC coil to be on the same legs with the AC coils is, however, counter intuitive from the starting point of Comparative Example 1. Such arrangement inherently presents increased AC circuit to DC circuit coupling, which may impact the fault current limiting performance of the device. Example 1, however, demonstrates that the limiting performance may be unhindered since less DC bias is required to achieve good magnetic saturation in the core

In the mentioned first embodiment of FIGS. 1a and 1b, the DC coils are wound around the AC coils. Hence, the AC coils are the inner coils, and the DC coils are the outer coils. It has been found that this can be advantageous. This is because during fault conditions this arrangement has less transformer coupling than when the DC coils are the inner coils.

It is known from transformer design that when one coil is wound around another, the coil carrying the higher voltage is the outer coil. This is because the higher the coil voltages, the larger is the required distance from the iron core. It has been found that in fault conditions parts of the core can become desaturated, in which case the AC and DC coils can behave in a similar way to a transformed. In such a case the voltage on the DC coil will depend on the turn ratio of the AC and DC coils.

Under normal conditions, in the FCL of FIGS. 1a and 1b the voltage on the AC coils is higher than the voltage of the DC coils, with the factor being between around to and around 1000. Hence, one might expect that that it would be advantageous to configure the FCL of FIGS. 1a and 1b with the DC coils as the inner (and not the outer) coils. In fact, in fault conditions in which the voltage on the AC coils rises dramatically, it has been found the voltage on the DC coils may actually be higher than the voltage on the AC coils depending on the turn ratio between AC and DC coils.

FIGS. 7a and 7b show a schematic of an FCL 200 according to a second embodiment of the invention.

The FCL 200 has three ferromagnetic cores: a first ferromagnetic core 201A, a second ferromagnetic core 201B and a third ferromagnetic core 201C. The FCL 200 is connected to the phases (R, S and T) of a three phase AC supply. FIG. 7b shows a top down view of the three ferromagnetic cores 201A, 201B, and 201C; while FIG. 7a shows a side view of the first ferromagnetic core 201A.

The first ferromagnetic core 200A comprises a first leg 202Aa and a second leg 202Ab. One end of the first and second legs is connected by a first yoke 203Aa and the other end of the first and second legs is connected by a second yoke 203Ab. The second and third ferromagnetic cores 201B and 201C are configured in a similar way.

In this embodiment, the FCL 200 comprises three pairs of AC coils, with each pair of AC coils being connected in series to one of the three phases of the AC supply. Compared to the arrangement of FIGS. 7a and 7b, the AC coils for each phase in this embodiment are split across the ferromagnetic cores.

For the R phase, there is a first AC coil 221Ra and a second AC coil 221Rb. For the S phase, there is a third AC coil 221Sa and a fourth AC coil 221Sb, and for the T phase, there is a fifth AC coil 221Ta and a sixth AC coil 221Tb.

As shown in FIG. 7b, for the R phase, the first AC coil 221Ra is wound on the first leg 202Aa of the first magnetically saturable core 201A, and the second AC coil 221Rb is wound on the second leg 202Cb of the third magnetically saturable core 201C.

For the S phase, the third AC coil 221Sa is wound on the second leg 202Aa of the first magnetically saturable core 201A, and the fourth AC coil 221Sb is wound on the first leg 202Ba of the second magnetically saturable core 201B.

For the T phase, the fifth AC coil 221Ta is wound on the second leg 202Bb of the second magnetically saturable core 201B, and the sixth AC coil 221Tb is wound the first leg 202Ca of the third magnetically saturable core 201C.

In this embodiment, each of the three magnetically saturable cores is provided with a magnetic biasing unit arranged to bias the magnetically saturable cores. In this embodiment, there are three magnetic biasing units, with each magnetic biasing unit being provided by a pair of DC coils. The three magnetic biasing units combine to form a magnetic biasing arrangement for the three cores 200A, 201B, and 201C.

For the first magnetically saturable core 201A, the magnetic biasing unit comprises a first DC coil 211Aa wound on the first leg 202Aa of the first magnetically saturable core 201A and a second DC coil 211Ab wound on the second leg 202Ab of the first magnetically saturable core 201A.

For the second magnetically saturable core 201B, the magnetic biasing unit comprises a third DC coil 211Ba wound on the first leg 202Ba of the second magnetically saturable core 201B and a fourth DC coil 211Bb wound on the second leg 202Bb of the second magnetically saturable core 201B.

For the third magnetically saturable core 201C, the magnetic biasing unit comprises a fifth DC coil 211Ca wound on the first leg 202Ca of the third magnetically saturable core 201C and a sixth DC coil 211Cb wound on the second leg 202Cb of the third magnetically saturable core 201C.

The legs and yokes of the cores 201R, 201S and 201T have, in this embodiment, interleaved, mitred, step-lapped joints. However, other embodiments can employ simpler arrangements, using non-mitred, butt-lapped joints. The cores are built from grain-oriented sheet steel laminations, though other embodiments could use alternative core structures. The coils (AC and DC) are made of electrolytic grade copper in this arrangement. However, other embodiments could use alternative materials for the coils.

The FCL 200 of this embodiment arrangement can further comprise a tank (not shown) arranged to house the three cores 201R, 201S and 201T. The tank can be partially or completely filled with a dielectric fluid. Any suitable dielectric fluid could be used, for example mineral oil or vegetable oil (which have been found to be suitable as a dielectric for voltages up to 300 kV and beyond).

FIG. 8 shows a schematic of the orientations of the AC and DC coils in the FCL according to the second embodiment.

In this embodiment, the two DC coils on each core provide a magnetic biasing means for that core that provides a closed magnetic circuit. The first DC coil 211Aa and the second DC coil 211Ab combine to produce a closed DC flux path inside (around) the first and second legs of the first core 201A. The third DC coil 211Ba and the fourth DC coil 211Bb combine to produce a closed DC flux path inside (around) the first and second legs of the second core 201B. The fifth DC coil 211Ca and the sixth DC coil 211Cb combine to produce a closed DC flux path inside (around) the first and second legs of the third core 201C.

Hence, in this embodiment, the closed DC flux flows in a clockwise direction in each of the three cores 200A, 201B, and 201C.

In this embodiment, the AC coils for each core 201A, 201B, 201C are wound so as to have polarities that are oriented in the same direction. For example, considering the first core 201A, the first AC coil 221Ra (for the R phase) on the first leg 202Aa is orientated in the same direction as the third AC coil 221Sa (for the S phase) on the second leg 202Ab. The arrows in FIG. 8 show the coils polarity by indicating the direction of the generated flux when the current through the coils is positive.

It will be appreciated that the three phases (R, S and T) of the three phase supply are shifted 120° apart. Therefore, in normal conditions, at a positive peak current for the R phase, both the S phase and the T phase will have small negative current. Likewise, at a positive peak current for the S phase, both the R phase and the T phase will have small negative current, and at a positive peak current for the T phase, both the R phase and the S phase will have small negative current.

As discussed, the orientations of the AC and DC coils in the FCL according to the first embodiment are shown in FIG. 8. The AC and DC coils are spaced apart in FIG. 8 for convenience of illustration. Considering FIG. 8, it will be appreciated that the flux in the 201A, 201B, and 201C can flow in a clockwise or counter-clockwise direction, depending on the varying currents (i.e. either positive or negative) in the AC coils and the currents in the DC coils.

As discussed, in this embodiment, the flux produced by the DC coils on each core combines to produce a closed DC flux path in a clockwise direction in each core.

Under normal conditions, the first and second legs of each core are kept in a saturated state by the DC coils. Depending on the point in the cycles, the AC flux from the three phase coils on each core will either support the DC flux on that core or oppose the DC flux on that core (while still maintaining saturation). Hence, under normal conditions, the AC coils for all three phases have very low impedance, and hence the FCL 200 is virtually transparent to the grid connected to the FCL 200.

If the FCL 200 is at positive peak current for the R phase, the first AC coil 221Ra (for the R phase) will generate AC flux in a clockwise direction. At this point in the cycle, the third AC coil 221Sa (for the S phase) will also generate AC flux in a clockwise direction as a result of the negative current at this point on the S phase (half the current of R phase in magnitude), as the first AC coil 221Ra and the third AC coil 221Sa have the same orientation. Hence, the AC flux in the first core 201A will be a closed loop.

Considering the third core 201C positive peak current for the R phase, the second AC coil 221Rb (for the R phase) will generate AC flux in a counter-clockwise direction, and the sixth AC coil 221Tb (for the T phase) will also generate AC flux in a counter-clockwise direction, again because the of the negative current at this point on the T phase and that the second AC coil 221Rb and the sixth AC coil 221Tb have the same orientation.

Hence, at positive peak current for the R phase, the AC flux from the R phase coils (i.e. the first AC coil 221Ra and the second AC coil 221Rb) supports the DC flux in the first core 201A and opposes the DC flux in the third core 201C. At the next half cycle (i.e. negative peak current for the R phase), the AC flux from the R phase coils (i.e. the first AC coil 221Ra and the second AC coil 221Rb) will oppose the DC flux in the first core 201A and support the DC flux in the third core 201C.

At positive peak current for the S phase, the third AC coil 221Sa (for the S phase) will generate AC flux in a counter-clockwise direction, and at this point in the cycle, the first AC coil 221Ra (for the R phase) will also generate AC flux in a counter-clockwise direction as a result of the 2o negative current at this point on the R phase, as the first AC coil 221Ra and the third AC coil 221Sa have the same orientation. Hence, the AC flux in the first core 201A will be a closed loop.

Considering the second core 201B at positive peak current for the S phase, the fourth AC coil 221Sb (for the S phase) will generate AC flux in a clockwise direction, and the fifth AC coil 221Ta (for the T phase) will also generate AC flux in a clockwise direction, again because the of the small negative current at this point on the T phase and that the fourth AC coil 221Sb and the fifth AC coil 221Ta have the same orientation.

Hence, at positive peak current for the S phase, the AC flux from the S phase coils (i.e. the third AC coil 221Sa and the fourth AC coil 221Sb) opposes the DC flux in the first core 201A and supports the DC flux in the second core 201B. At the next half cycle (i.e. negative peak current for the S phase), this will reverse.

At positive peak current for the T phase, the fifth AC coil 221Ta (for the T phase) will generate AC flux in a counter-clockwise direction, and at this point in the cycle, the fourth AC coil 221Sb (for the S phase) will also generate AC flux in a counter-clockwise direction as a result of the negative current at this point on the S phase, as the fifth AC coil 221Ta and the fourth AC coil 221Sb have the same orientation. Hence, the AC flux in the second core 201B will be a closed loop.

Considering the third core 201C at positive peak current for the T phase, the sixth AC coil 221Tb (for the T phase) will generate AC flux in a clockwise direction, and the second AC coil 221Rb (for the R phase) will also generate AC flux in a clockwise direction, again because the of the negative current at this point on the R phase and that the sixth AC coil 221Tb and the second AC coil 221Ra have the same orientation.

Hence, at positive peak current for the T phase, the AC flux from the T phase coils (i.e. the fifth AC coil 221Ta and the sixth AC coil 221Tb) opposes the DC flux in the second core 201B and supports the DC flux in the third core 201C. At the next half cycle (i.e. negative peak current for the T phase), this will reverse.

Under normal conditions, the first and second legs of each core are kept in a saturated state by the DC coils that are arranged to produce DC flux in the clockwise direction. Depending on the point in the cycles for the three phases, the AC flux from the three phase coils on each core will either support the DC flux on that core or oppose the DC flux on that core (while still maintaining saturation). Hence, under normal conditions, the AC coils for all three phases have very low impedance, and hence the FCL 200 is virtually transparent to the grid connected to the FCL 200.

Under fault conditions, because the two AC coils on each core belong to different phases, the AC fluxes generated by them are phase shifted. Therefore, during fault the AC fluxes in some parts of the cycle have a magnetic loop ths closed and this increases inductance compared to fully open magnetic circuit. This closed AC magnetic loop increases inductance and fault limitation.

As discussed, the embodiment of FIGS. 1a and 1b produces a closed DC flux loop and an open AC flux loop. In contrast, in this embodiment, during a fault the flux from the AC coils can form a closed loop in some parts of the cycle. Hence, in this embodiment, the FCL has the characteristics of a closed-closed arrangement in some parts of the cycle, while being structurally similar to the embodiment of FIGS. 1a and 1b.

A comparison will now be made between an example FCL configured in the manner of FIGS. 1a and 1b (Example 3) and an FCL according to the second embodiment (Example 2).

In this comparison, certain FCL parameters were fixed for an FCL according to an embodiment of the present invention configured as illustrated in FIGS. 7a and 7b (Example 2) and an embodiment configured as illustrated in FIGS. 1a and 1b (Example 3), and then other FCL parameters were varied with the aim of making it so that all the FCL configurations have the same (or very nearly the same) current limitation for a maximum asymmetric fault condition, with the same prospective steady state rms fault current.

In other words, in order to compare the FCL configurations of the Example 2 and Example 3, configuration of the terminal connections between AC coils in the electrical circuit were changed. Apart from that the devices are identical (system voltage, prospective current, nominal current, DC current, AC and DC coils turns and dimensions, core dimensions, clearances, etc.).

In this comparison, the following grid parameters were fixed:

a. Through power: 469 MVA
b. Line voltage: 220 kV
c. Nominal current: 1.23 kA
d. Prospective RMS current: 9.7 kA
e. Prospective peak current: 24.2 kA

The following design parameters were fixed:

a. DC current: 480 A
b. DC coils turns: 532
c. AC coils turns: 142
d. Core diameter: 495 mm
e. AC coil length: 1800 mm
f. DC coil length: 1600 mm
g. AC coil thickness: 65 mm
h. DC coil thickness: 1500 mm Table 5 compares the nominal performances of Example 2 and Example 3.

TABLE 5

| | Example 3 | | | Example 2 | | |
|---|---|---|---|---|---|---|
| | R phase | S phase | T phase | R phase | S phase | T phase |
| | insertion | insertion | insertion | insertion | insertion | insertion |
| Voltage drop [kV] | 3.97 | 4.04 | 4 | 4.07 | 4.06 | 4.05 |
| Insertion | 3.13% | 3.18% | 3.15% | 3.20% | 3.20% | 3.19% |

Table 6 compares the fault performances of Example 2 and Example 3.

TABLE 6

| | Example 3 | | Example 2 | | |
|---|---|---|---|---|---|
| | Current | | Current | | Prospective |
| | [A] | Limitation | [A] | Limitation | Current [A] |
| Steady state 3 | 6153 | 36.31% | 5890 | 39.03% | 9661 |
| phase fault | | | | | |
| Maximum | 17050 | 29.46% | 16680 | 30.99% | 24170 |
| asymmetry 3 | | | | | |
| phase fault | | | | | |

It is clear from Tables 5 and 6 that there is a clear improvement in fault limiting performance, with similar insertion impedance, when comparing Example 2 to Example 3. Hence, an FCL according to such an embodiment of the invention could be made with the same dimensions with better fault limiting performance than an FCL according to Example 3, or could be made with the smaller dimensions and have the same fault limiting performance as an FCL according to Example 3.

As discussed, in the above mentioned embodiments of FIGS. 1a and 1b and 7a and 7b, the DC coils are wound around the AC coils. However, it will be appreciated that other embodiments can have the DC coils as the inner coils, with the AC coils as the outer coils. Hence, in an embodiment that is a variation of the first embodiment, the AC coils can be wound around the DC coils on each of the first and second legs.

In the above mentioned embodiments, the DC coil on each leg is wound around the AC coils so as to overlap the AC coils. However, it will be appreciated that other embodiments can have a DC coil for each core acting as a magnetic biasing unit wound around the first and second legs in different configurations.

For example, in an embodiment that is a variation of the first and second embodiments, the AC coils for a core can be wound around an upper portion of the first and second legs, with a DC coil wound around a lower portion of each of the first and second legs, as shown in FIG. 9a. Alternatively, it will be appreciated that the AC coils for a core could be wound around a lower portion of the first and second legs, with the DC coils wound around an upper portion of the first and second legs. In such arrangements, the DC coil does not overlap the AC coils.

In addition, in a further variation of the first and second embodiments, the magnetic biasing unit could be provided as two or more DC coils for each leg, with two DC coil wound around each of the first and second legs. An example of such an arrangement is shown in FIG. 9b in which two DC coils are provided for each core, with the DC coils arranged either side of the AC coils.

In some embodiments of the invention that have three cores, the magnetic biasing could be provided by a first DC coil wound around the first leg of the first, second and third magnetically saturable cores, and a second DC coil wound around the second leg of the first, second and third magnetically saturable cores. Such an arrangement is shown schematically in FIGS. 10a and 10b.

FIG. 10b shows a top down view of the three ferromagnetic cores, while FIG. 10a shows a side view of the three ferromagnetic cores.

Each of the three cores comprises two legs connected by a yoke, in a similar structural configuration to the embodiment shown in FIGS. 1a and 1b. The difference between the embodiment of FIGS. 1a and 1b and the embodiment of FIGS. 10a and 10b, is that in the embodiment of FIGS. 10a and 10b, the DC coil for each first leg of the cores is common to all three cores, and the DC coil for each second leg of the cores is common to all three cores.

In other words, in the embodiment of FIGS. 10a and 10b, the magnetic biasing units of the first, second and third magnetically saturable cores comprises a first DC coil wound around the first legs of the first, second and third magnetically saturable cores, and a second DC coil wound around the second legs of the first, second and third magnetically saturable cores.

In embodiments of the invention that have three cores, the magnetic biasing could be provided by a DC coil wound around all of the legs of the first, second and third magnetically saturable cores. Such an arrangement is shown schematically in FIG. 11, which shows a top down view of the three ferromagnetic cores.

Each of the three cores comprises two legs connected by a yoke, in a similar structural configuration to the embodiment shown in FIGS. 1a and 1b. The difference between the embodiment of FIGS. 1a and 1b and the embodiment of FIG. 11, is that in the embodiment of FIG. 11, there is a common DC coil for all the legs of the three cores.

In other words, in the embodiment of FIG. 11, the magnetic biasing units of the first, second and third magnetically saturable cores comprises a common DC coil for the first, second and third magnetically saturable cores, the common DC coil being wound around both the first and second legs of all of the magnetically saturable cores. In the embodiment of FIG. 11, the FCL may be operated with open DC magnetic circuits and closed AC magnetic circuits.

The above mentioned embodiments show FCLs with three cores, with each core having two AC coils for a different phase of a 3 phase supply or with the AC coils split for each core. Hence, the above mentioned embodiments show 3-phase FCLs with three cores. In some such embodiments, the first, second and third cores can be arranged in vertically or horizontally in said same tank. In other embodiments, the first, second and third cores can be arranged in separate tanks, each tank being partially or fully filled with a dielectric fluid.

As discussed, when comparing the embodiment of FIGS. 7a and 7b to the embodiment of FIGS. 1a and 1b, an important difference is that the AC coils for each phase are not located on the same core (as in FIGS. 1a and 1b), but are split among the cores. Hence, in FIGS. 7a and 7b, the AC coils are arranged as RS, ST, TR on the three cores. It will, however, be appreciated that the AC coils could be split among the three cores in different configurations.

Furthermore, although the above mentioned embodiments discuss a 2 legged FCL with AC and DC coils on the same legs as each other on each core, embodiments of the invention are not limited to this.

For example, some embodiments of the invention could be structurally configured in a similar way to the FCL shown in FIGS. 3a and 3b. For example, some embodiments of the invention may employ an orthogonal arrangement of the DC and AC coils (e.g. as shown in FIGS. 3a and 3b), with the AC coils arranged as RS, ST, TR pairs on the three cores.

The FCL shown in FIGS. 3a and 3b may be considered to be a four legged FCL with the AC coils on one set of opposing legs (e.g. first and second legs) and the DC coils on the other set of opposing legs (e.g. third and fourth legs).

In variations of such embodiments, the magnetic biasing arrangement for the FCL. However, the magnetic biasing arrangement could be arranged in other ways, for example using a single DC coil for each core that is wound around the other set of opposing legs (e.g. third and fourth legs).

Other embodiments of the invention can have other structural configurations. In general, some embodiments of the invention can provide an FCL comprising first, second and third magnetically saturable cores, with the fault current limiter comprising: a magnetic biasing arrangement arranged to produce a first closed magnetic circuit in the first magnetically saturable core, a second closed magnetic circuit in the second magnetically saturable core, and a third closed magnetic circuit in the third magnetically saturable core. First and second AC coils (for the R phase) are connected in series and connected to a first phase AC source, with the first AC coil wound on a portion of the first magnetically saturable core and the second AC coil wound on a portion of the third magnetically saturable core. Third and fourth AC coils (for the S phase) are connected in series and connected to a second phase AC source, with the third AC coil wound on a portion of the first magnetically saturable core and the fourth AC coil wound on a portion of the second magnetically saturable core. Fifth and sixth AC coils (for the T phase) are connected in series and connected to a third phase AC source, with the fifth AC coil wound on a portion of the second magnetically saturable core and the sixth AC coil wound on a portion of the third magnetically saturable core.

In some embodiments, the coils (AC and/or DC) may be spread around the core.

In the above embodiments, the AC coils are on first and second legs of the FCL. However, the FCL could have other arrangements. For example, the first, second and third magnetically saturable cores may each comprise a first leg and a flux return path. The flux return path may be a portion of the magnetically saturable core that enables flux to flow in a closed loop back to the first leg. It will be appreciated that the flux return path could have various structural configurations.

In such embodiments, the first AC coil (for the R phase) may be wound on the first leg of the first magnetically saturable core and the second AC coil (for the R phase) may be wound on the first leg of the third magnetically saturable core; the third AC coil (for the S phase) may be wound on the first leg of the first magnetically saturable core and the fourth AC coil (for the S phase) may be wound on the first leg of the second magnetically saturable core; and the fifth AC coil (for the T phase) may be wound on the first leg of the second magnetically saturable core and the sixth AC coil (for the T phase) may be wound the first leg of the third magnetically saturable core.

Hence, in such arrangements, the first leg of each core comprises two AC coils, with each coil being of separate phases (e.g. in RS, ST, TR pairs). The two AC coils on each first leg may be wound concentrically or may be spaced apart on the third leg.

In such arrangements, the magnetic biasing arrangement may comprise one or more DC coils or alternative arrangements such as permanent magnets. For example, the magnetic biasing arrangement may comprises a first DC coil wound on the first leg of the first magnetically saturable core; a second DC coil wound on the first leg of the second magnetically saturable core; and a third DC coil wound on the first leg of the third magnetically saturable core. Such DC coils may be wound concentrically with the AC coils on the first leg or spaced apart therefrom. It will be appreciated that any of the above mentioned structural modifications could be combined in any suitable way.

It will be also appreciated that some of the above mentioned modifications may be performed with bias units as permanent magnets in addition to or instead of said DC bias coils.

It will also be appreciated that some three core embodiments of the invention could use a single core for a single phase FCL.

In some embodiments, for example a fifth embodiment (not shown) a three phase FCL (R, S, T) can be provided using a single core. In such an embodiment, an FCL can be provided with first and second legs connected by yokes in the general core configuration of FIG. 1.

In such an embodiment, there are two AC coils for each of three phases R, S, T of the AC supply. Considering the coils for the R phase, there can be first to third AC coils on the first leg, and first to third AC coils on the second leg. These coils could be arranged in order, or in other configurations. Each of the first and second legs could have a DC coil wound around the three AC coils. The AC coils, DC coils on the S and T phases could be arranged in the same way. The AC coils for each of the three phases could be wound so as to each produce an AC magnetic flux within the first and second legs that opposes the DC flux in one leg and supports the DC flux in the other leg, with the situation reversing in the next half cycle.

When limitation of three and two phase faults is required, then asymmetric coil designs between the phases could be used. The asymmetry in coil design could be achieved in a number of different ways. For example, it could be achieved by having a different number of coil turns, or by having different coil dimensions (e.g., with phase R coils being shorter than the phase S coils). In addition, the asymmetry in coil design could be achieved by having the coils of different phases placed apart so that they are not perfectly overlapping, or by inversing the coil polarity of one of the coils of the phases. Furthermore, the asymmetry in the coil design can be achieved using a combination of the above ways.

Such methods of including asymmetry in the coil design break the symmetry between the different phases and therefore allow three phase symmetrical fault limitation and three phase fault limitation because there is no total flux cancellation between phases.

When such methods of including asymmetry in the coil design means are included this asymmetry is also present during normal operation, but is overcome by the saturation means.

In the above mentioned fourth embodiment, a DC coil could be wound around the AC coils so as to overlap all the AC coils. However, it will be appreciated that other embodiments can have one or more DC coils acting as a magnetic biasing unit wound around both the first and second legs in different configurations.

Furthermore, it will be appreciated that the AC coils could be arranged in a number of ways. In the fifth embodiment, the R and S AC coils on one leg can be spaced apart from each other with the T coil overlapping the R and S coils, with the R coils on the lower portion of the legs and the S coils on the upper portion of the legs. In other embodiments, on one leg the R coil could be arranged on the lower portion with the S coil on the upper portion, with on the other leg the R coil could be arranged on the upper portion with the S coil on the lower portion.

Furthermore, in other embodiments, the R, S and T coils could be arranged in a row in a non-overlapping manner. For example, the AC coils on one leg could be arranged in the order R, S, T along the leg, with the AC coils on the other leg being arranged in the order T, S, R.

In addition, in a further variation of the fifth embodiment, all three AC coils on the inner legs could be arranged to be overlapping in a concentric arrangement. For example, the AC coils on one inner leg could be arranged in the order R, S, T from out to in, with the AC coils on the other inner leg being arranged in the order T, S, R from out to in.

Furthermore, it will be appreciated any of these variations could be combined in any suitable way.

In the many of the above embodiments, the DC coil(s) are arranged outside of the AC coils on the same leg. However, the embodiments of the invention are not limited to this. In other similar embodiments (i.e. embodiments with similar structural arrangements to those above), the DC coil(s) can be arranged inside of the AC coil(s) on the same leg.

As discussed, it has been found that having the DC coil(s) are arranged outside of the AC coils on the same leg is, counter intuitively, advantageous.

In the many of the above embodiments, the DC coil(s) are arranged to produce a closed DC magnetic circuit, and the AC coils are arranged to produce open AC magnetic circuits. However, the embodiments of the invention are not limited to this.

In other similar embodiments (i.e. embodiments with similar structural arrangements to those above), the DC coil(s) can be arranged to produce an open DC magnetic circuit, and the AC coils can be arranged to produce closed AC magnetic circuits

The DC closed/AC open arrangement is advantageous over the DC open/AC closed arrangement because less ampere-turns for the DC coil are needed for approaching applicable saturation level.

In the above embodiments the core (or cores) is built from grain-oriented sheet steel laminations, though other embodiments could use alternative core structures. The various legs and yokes have, in some embodiments, interleaved, mitred, step-lapped joints. However, other embodiments can employ simpler arrangements, using non-mitred, butt-lapped joints.

The coils (AC and DC) are made of electrolytic grade copper in this arrangement. However, other arrangement could use alternative materials for the coils.

In embodiments of the invention, the AC coils may be formed from any suitable material, such as aluminium or copper. Furthermore, the DC coils can be any suitable material, for example aluminium, copper, low temperature superconductor or a high temperature superconductor. In other embodiments, the DC coils could be replaced by a suitable DC biasing means. In other embodiments, the DC coils could be supplemented by permanent magnets. In some embodiments, the biasing means may use a non-HTS DC coils.

Some embodiments employ fluid around the all or part of windings, such as mineral oil, vegetable oil or cryogenic fluid.

Some embodiments, for example for small FCLs, may employ dry type solid insulation and air around the windings with a tank/enclosure.

The AC and DC windings can have various shapes, such as circular, rectangular, oval or race-track shapes. Furthermore, the core legs and yokes can have circular (cruciform), oval or rectangular cross-section. The AC and DC coils can be wound on circular, oval or rectangular formers.

Many further variations and modifications will suggest themselves to those versed in the art upon making reference to the foregoing illustrative embodiments, which are given by way of example only, and which are not intended to limit the scope of the invention, that being determined by the appended claims

1. A fault current limiter comprising first, second and third magnetically saturable cores, the fault current limiter comprising:
a magnetic biasing arrangement arranged to produce a first magnetic circuit in the first magnetically saturable core, a second magnetic circuit in the second magnetically saturable core, and a third magnetic circuit in the third magnetically saturable core;
first and second AC coils connected in series and connected to a first phase AC source, wherein the first AC coil is wound on a portion of the first magnetically saturable core and the second AC coil is wound on a portion of the third magnetically saturable core;
third and fourth AC coils connected in series and connected to a second phase AC source, wherein the third AC coil is wound on a portion of the first magnetically saturable core and the fourth AC coil is wound on a portion of the second magnetically saturable core; and
fifth and sixth AC coils connected in series and connected to a third phase AC source, wherein the fifth AC coil is wound on a portion of the second magnetically saturable core and the sixth AC coil is wound on a portion of the third magnetically saturable core.

2. A fault current limiter according to claim 1, wherein the first, second and third magnetically saturable cores each comprise a first leg and a second leg, wherein:
the first AC coil is wound on the first leg of the first magnetically saturable core and the second AC coil is wound the second leg of the third magnetically saturable core;
the third AC coil is wound on the second leg of the first magnetically saturable core and the fourth AC coil is wound on the first leg of the second magnetically saturable core;
the fifth AC coil is wound on the second leg of the second magnetically saturable core and the sixth AC coil is wound on the first leg of the third magnetically saturable core.

3. A fault current limiter according to claim 2, wherein the magnetic biasing unit arrangement comprises:
a first DC coil wound on the first leg of the first magnetically saturable core and a second DC coil wound on the second leg of the first magnetically saturable core;
a third DC coil wound on the first leg of the second magnetically saturable core and a fourth DC coil wound on the second leg of the second magnetically saturable core;
a fifth DC coil wound on the first leg of the third magnetically saturable core and a sixth DC coil wound on the second leg of the third magnetically saturable core.

4. A fault current limiter according to claim 3, wherein:
the first DC coil and the first AC coil are wound concentrically;
the second DC coil and the third AC coil are wound concentrically;
the third DC coil and the fourth AC coil are wound concentrically;
the fourth DC coil and the fifth AC coil are wound concentrically;
the fifth DC coil and the sixth AC coil are wound concentrically; and
the sixth DC coil and the second AC coil are wound concentrically.

5. A fault current limiter according to claim 4, wherein:
the first DC coil is wound around the first AC coil;
the second DC coil is wound around the third AC coil;
the third DC coil is wound around the fourth AC coil;
the fourth DC coil is wound around the fifth AC coil;
the fifth DC coil is wound around the sixth AC coil; and
the sixth DC coil is wound around the second AC coil.

6. A fault current limiter according to claim 2, wherein the magnetic biasing arrangement comprises:
a first DC coil wound around the first legs of the first, second and third magnetically saturable cores;
a second DC coil wound around the second legs of the first, second and third magnetically saturable cores.

7. A fault current limiter according to claim 2, wherein the first, second and third magnetically saturable cores each further comprise a third leg and a fourth leg, wherein the magnetic biasing unit arrangement comprises:
a first DC coil wound on the third leg of the first magnetically saturable core and a second DC coil wound on the fourth leg of the first magnetically saturable core;
a third DC coil wound on the third leg of the second magnetically saturable core and a fourth DC coil wound on the fourth leg of the second magnetically saturable core;
a fifth DC coil wound on the third leg of the third magnetically saturable core and a sixth DC coil wound on the fourth leg of the third magnetically saturable core.

8. A fault current limiter according to claim 1, wherein the first, second and third magnetically saturable cores each comprise a first leg and a flux return path, wherein:
the first AC coil is wound on the first leg of the first magnetically saturable core and the second AC coil is wound the first leg of the third magnetically saturable core;
the third AC coil is wound on the first leg of the first magnetically saturable core and the fourth AC coil is wound on the first leg of the second magnetically saturable core;
the fifth AC coil is wound on the first leg of the second magnetically saturable core and the sixth AC coil is wound the first leg of the third magnetically saturable core.

9. A fault current limiter according to claim 8, wherein:
the first AC coil and the third AC coil are wound concentrically;
the fourth AC coil and the fifth AC coil are wound concentrically; and
the sixth AC coil and the second AC coil are wound concentrically.

10. A fault current limiter according to claim 8 or 9, wherein the magnetic biasing arrangement comprises:
a first DC coil wound on the first leg of the first magnetically saturable core;
a second DC coil wound on the first leg of the second magnetically saturable core;
a third DC coil wound on the first leg of the third magnetically saturable core.

11. A fault current limiter according to claim 10, wherein:
the first AC coil and the first DC coil are wound concentrically;
the fourth AC coil and the second DC coil are wound concentrically; and
the sixth AC coil and the third DC coil are wound concentrically.

12. A fault current limiter according to claim 8 or 9, wherein the magnetic biasing arrangement comprises:
a first DC coil wound around the first leg of the first, second and third magnetically saturable core.

13. A fault current limiter according to any one of claims 1 to 12, wherein the first magnetic, the second magnetic circuit, and the third magnetic circuit are closed magnetic circuits.

14. A fault current limiter according to claim 2, wherein the magnetic biasing arrangement comprises:
a first DC coil wound around the first and second legs of the first magnetically saturable core;
a second DC coil wound around the first and second legs of the second magnetically saturable core;
a third DC coil wound on the first and second legs of the third magnetically saturable core.

15. A fault current limiter according to claim 2, wherein the magnetic biasing unit arrangement comprises:
a DC coil wound around the first and second legs of the first, second and third magnetically saturable cores.

16. A fault current limiter according to any one of claims 1 to 15, wherein the first, second and third cores are separate.

17. A fault current limiter according to claim 16, wherein the first, second and third cores are arranged in vertically or horizontally in said same tank; or
wherein the first, second and third cores are arranged in separate tanks, each tank being partially or fully filled with a dielectric fluid.

18. A fault current limiter comprising a first magnetically saturable core, a second magnetically saturable core, and a third magnetically saturable core, each magnetically saturable core respectively including:
a first leg, with a first AC coil wound on the first leg;
a second leg, with a second AC coil wound on the second leg, the first and second AC coils being connected in series;
a magnetic biasing unit arranged to produce a DC magnetic circuit in the first leg and the second leg;
wherein first ends of the first and second legs are joined by a first yoke and second ends of the first and second legs are joined by a second yoke;
wherein the first and second AC coils are arranged to produce AC magnetic flux in the first and second legs that alternates in direction with each AC half-cycle.
wherein the first and second AC coils of the first magnetically saturable core are connected to a first phase AC source, the first and second AC coils of the second magnetically saturable core are connected to a second phase AC source, and the first and second AC coils of the third magnetically saturable core are connected to a third phase AC source.

19. A fault current limiter according to claim 18, wherein the first and second AC coils are arranged to produce an open AC magnetic circuit and the magnetic biasing unit is arranged to produce a closed DC magnetic circuit,

20. A fault current limiter according to claim 18, wherein the first and second AC coils are arranged to produce a closed AC magnetic circuit and the magnetic biasing unit is arranged to produce an open DC magnetic circuit.

21. A fault current limiter according to claim 18 or 19, wherein the magnetic biasing unit of each magnetically saturable core comprises a first DC coil wound around the first leg and a second DC coil wound around the second leg.

22. A fault current limiter according to claim 20, wherein each first DC coil is wound around the first AC coil of the respective magnetically saturable core and each second DC coil is wound around the second AC coil of the respective magnetically saturable core.

23. A fault current limiter according to claim 20 or 21, wherein on each magnetically saturable core the first DC coil and the first AC coil are wound concentrically around the first leg, and on each magnetically saturable core the second DC coil and the second AC coil are wound concentrically around the second leg.

24. A fault current limiter according to claim 18, wherein the magnetic biasing units of the first, second and third magnetically saturable cores comprise a common DC coil for the first, second and third magnetically saturable cores, the common DC coil being wound around both the first and second legs of all of the magnetically saturable cores.

25. A fault current limiter according to claim 18, wherein the magnetic biasing units of the first, second and third magnetically saturable cores comprise a first DC coil wound around the first legs of the first, second and third magnetically saturable cores, and a second DC coil wound around the second legs of the first, second and third magnetically saturable cores.
